(19) United States
(12) Patent Application Publication
(10) Pub. No.: US 2002/0083546 A1
(43) Pub. Date: Jul. 4, 2002

(54) Wiper blade structure for an automobile

(76) Inventor: Keun-Sik Lim, Kyoungki-do (KR)

Correspondence Address: Pennie & Edmonds, LLP, 3300 Hillview Avenue, Palo Alto, CA, 94304, US

(21) Appl. No.: 10/033,425

(22) Filed: Dec. 27, 2001

(30) Foreign Application Priority Data
Dec. 29, 2000 (KR) 2000-85259

(51) Int. Cl. B60S 1/38

(52) U.S. Cl. 15/250.44; 15/250.452

(57) ABSTRACT

The present invention is to provide a wiper blade structure for an automobile comprising: a rubber molded in such a manner that a blade and a spoiler are integrally formed; two vertebrae inserted at both sides of the rubber with lying on the same plane; and a fastener encompassing and fixing the rubber and two vertebrae at both ends of the rubber.

### FIELD OF THE INVENTION

The present invention relates to a wiper blade structure for an automobile and more particularly, to a wiper blade structure that is capable of evenly distributing the load acting on the wiper throughout the whole length of a wiper blade and also suppressing the lifting tendency of a wiper blade.

### BACKGROUND OF THE INVENTION

In general, a conventional wiper system provided for an automobile comprises a wiper blade assembly that is attached close on windshield so as to wipe off rainwater, dust, etc. from a windshield glass, and a link assembly that delivers the driving force generated by a wiper motor to the wiper blade assembly. The wiper blade assembly typically comprises a wiper arm, which is connected to the link assembly so as to make its pivotal movement, and a wiper blade structure that is mounted at one end of the wiper arm so as to wipe a windshield glass.

As illustrated in FIG. 2, such a wiper blade structure comprises a rubber 100 for wiping a windshield glass, two vertebrae 110 which are inserted at both sides of the rubber 100 in order to reinforce the wiper blade structure, and a yoke 120 firmly grabbing the rubber 100 in such a way that it encompasses the upper portion of the rubber 100 and two vertebrae 110.

However, the conventional wiper blade structure is made of rubber as well as various kinds of steels (e.g. yoke, two levers, etc.) and has many gaps in order to assemble each components of a wiper blade assembly. For this reason, noise occurs when operating the wiper system, thus resulting in degrading the ride comfort. Additionally, when the wiper blade is actuated while driving at high speed, the wiper blade may lift from a windshield glass. For the purpose of preventing this lifting tendency, a so-called spoiler may be added, thus increasing the cost and weight.

### SUMMARY OF THE INVENTION

The present invention provides a wiper blade structure for an automobile that is manufactured in such a manner that the spoiler and blade are integrally formed as a body so that the number of the components used in assembling the wiper blade can be decreased. As a result, the noise is considerably reduced and the lifting tendency of the wiper blade from a windshield glass is suppressed.

According to an alternative preferred embodiment, a wiper blade rubber has a blade portion and a body portion integrally molded as a single piece. The body portion defines outwardly open, longitudinally extending channels on either side. Stiffening vertebrae are disposed in channels. The vertebrae have a width greater than the channel depth such that the vertebrae extend beyond the body portion. At least two fasteners conform to the outer profile of the rubber and stiffening vertebra to hold the vertebrae in place. The fasteners may include outward extending flange sections surrounding the vertebrae. Preferably, the rubber further comprises an integrally molded spoiler portion extending from the body portion opposite the blade portion and running longitudinally along the body portion. In this case, the fasteners are shaped to accommodate the spoiler portion.

Preferably, the wiper blade structure according to the invention exhibits a lifting force of less than about 30 N at a vehicle speed of approximately 200 km/hr. More preferably the lifting force is less than about 25 N under the same conditions. Also, the wiper blade structure preferably applies a distributed load to the vehicle wind shield that is substantially constant over a middle section of the wiper blade structure. In a further preferred embodiment, the middle section comprises at least about 60% to 68% of the length of the wiper blade structure.

### BRIEF DESCRIPTION OF THE DRAWINGS

The above object and feature of the present invention will become apparent from the following description of the invention, when taken in conjunction with the accompanying drawings, in which:

FIG. 1 is a perspective view of a wiper blade structure in accordance with the present invention;

FIG. 2 is a sectional view of the conventional wiper blade structure;

FIGS. 3a is a graph showing the distributed load acted on the conventional wiper blade according to the length of the wiper blade;

FIGS. 3b is a graph showing the distributed load acted on the wiper blade of the present invention according to the length of the wiper blade; and

FIG. 4 is a graph showing the lifting results of both the wiper blade structure of the present invention and the conventional wiper blade structure according to the driving speed.

### DETAILED DESCRIPTION OF THE PREFERRED EMBODIMENTS

According to a preferred embodiment of the present invention, a wiper blade structure comprises a rubber molded in such a manner that a blade and a spoiler are integrally formed; two vertebrae inserted at both sides of the rubber with lying on the same plane; and a fastener encompassing and fixing the rubber and two vertebrae at both ends of the rubber. Preferably, two grooves are formed along the entire length of the rubber for insertion of two vertebrae. The two vertebrae are characterized by being outwardly protruded from both sides of the rubber and also being made of plate spring.

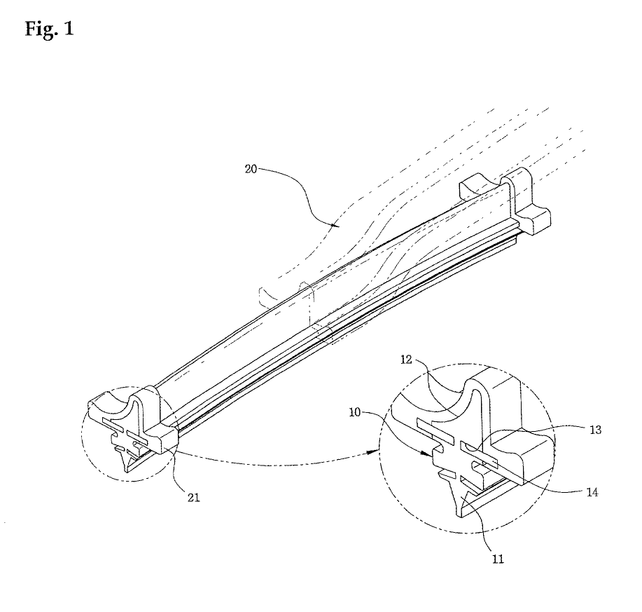

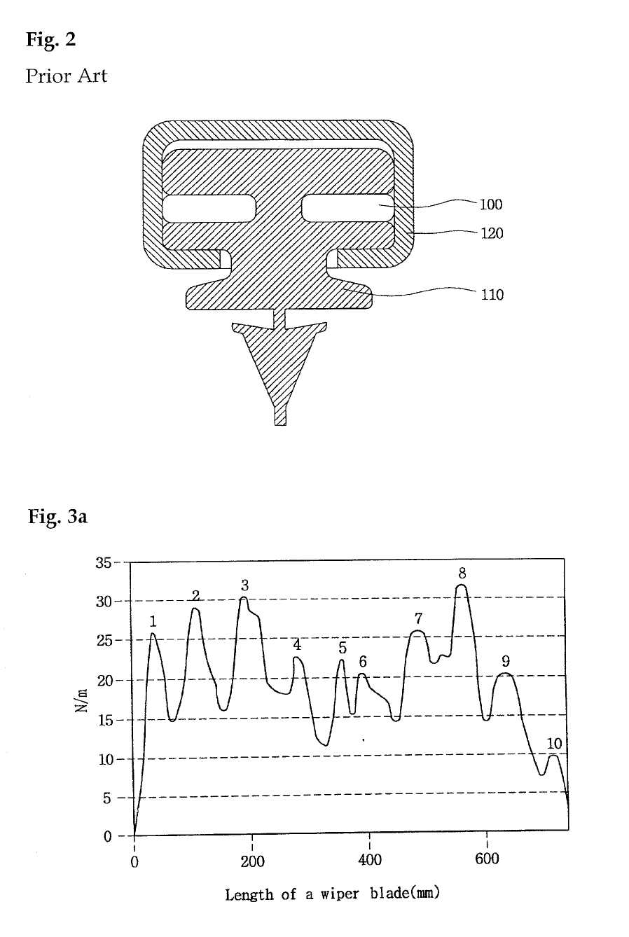

More specifically as shown in FIG. 1, rubber 10, including blade 11 for wiping a windshield and spoiler 12 for preventing the blade from being lifted off a windshield while driving, are integrally molded together. Two grooves 13 are formed along the entire length at both sides of the rubber 10. Two vertebrae 14 are inserted into said two grooves 13.

In a preferred alternative embodiment, the two vertebrae 14 are molded together with rubber 10. The panel shaped vertebrae 14, which are much longer in their length than in their height and width, respectively, are preferably made of plate spring (i.e., spring steel) so they can be deformed to maintain a close contact with the curved surface of a windshield. Therefore, the load delivered from the wiper arm is evenly distributed throughout the whole length of the wiper blade.

In addition, it is preferable that the width of the vertebrae 14 is designed to be larger than that of the groove 13 so that the wiper blade is maintained closer to the curved surface of a windshield by the load delivered from the wiper arm 20 and spoiler 12.

At both ends of the wiper blade, a fastener 21 is mounted for fixing two vertebrae 14 into the rubber 10. At the middle portion of the wiper blade, the wiper arm 20 is connected for supporting the rubber 10 and two vertebrae 14. One end of the wiper arm 20 is manufactured in the same shape as the fastener 21 in order to support the rubber 10, encompassing the spoiler 12 and two vertebrae 14.

Fastener 21 is preferably molded to encompass spoiler 12 with a flange formed along the edges of the fastener 21 encompassing the vertebrae 14 protruding from the groove 13.

With respect to the wiper blade structure of the present invention and conventional wiper blade structure, the experimental results of the distributed load and lift experiments are as follows.

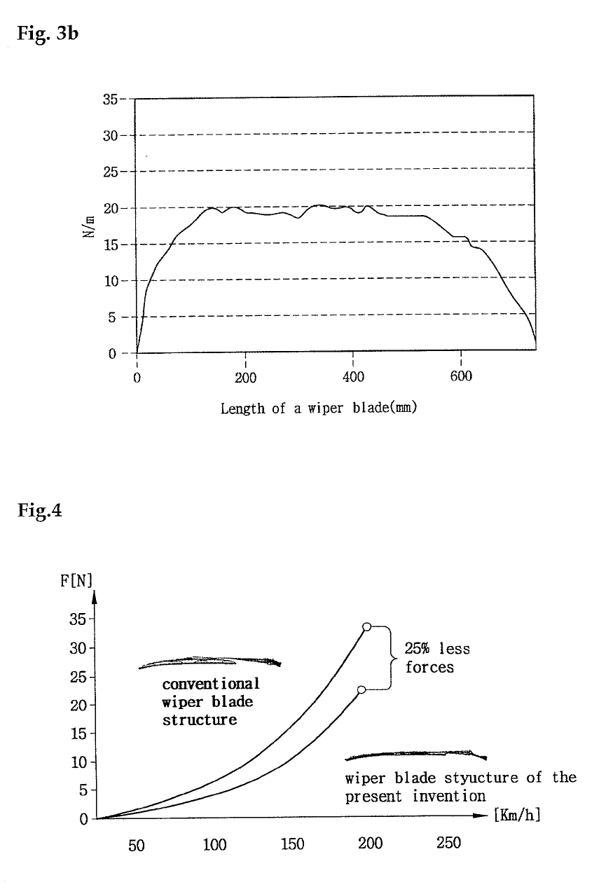

The graphs of FIGS. 3a-3b show the distributed load acted on the conventional wiper blade and wiper blade of the present invention. The length of the wiper blade used in the experiments was 680 mm and the experiments were carried out under the identified conditions.

In the case of the conventional wiper blade structure, as shown in FIG. 3a, the distributed load repeatedly fluctuated at each point depicted as 1-10. Especially, in the middle portion of the wiper blade and the point depicted as 8, the distributed load greatly fluctuated. On the contrary, in the case of the wiper blade of the present invention, as shown in FIG. 3b, the load acting on the wiper blade is evenly distributed throughout the length of the wiper blade except for the extreme ends. As can be seen in the figure, the load is substantially evenly distributed over about 410-460 mm, or at least about 60% to 68% of the total wiper length. Therefore, the windshield glass can be more uniformly cleaned by the present invention.

As shown in the graphs of FIG. 4, the lifting forces acting on the wiper blade are presented in accordance with the driving speed. The slope of the curve for the conventional blade is steeper than that for the blade of the present invention. As such, it can be seen that the lifting force increases, and performance therefore decreases more dramatically with speed in the conventional wiper. In general, as can be seen from the figure, the lifting force exhibited by the present invention is less than about 30N and, more preferably, less than about 25N, at a speed of approximately 200 km/h. The present invention is superior to the conventional wiper blade structure by at least about 25% in the lifting performance.

As described above, the wiper blade structure of the present invention provides at least the following advantages:

1) Because the construction of the present wiper blade structure is simple in contrast to that of the conventional wiper blade structure, the number of components used in a wiper blade assembly, manufacturing processes, cost and weight can be considerably reduced;

2) The reduction of the components made of steel remarkably reduces the noise occurred by interference among each component;

3) The load delivered from the wiper arm is evenly distributed throughout the whole length of a wiper blade so that the wiper blade can uniformly cleanly wipe a windshield glass; and

4) As to the spoiler integrally molded with a blade, its configuration will be designed to have various shapes according to the kinds of automobiles.

What is claimed is:

1. A wiper blade structure for an automobile, comprising:
a rubber molded in such a manner that a blade and a spoiler are integrally formed;
two vertebrae inserted at both sides of the rubber with lying on the same plane; and
at least one fastener encompassing and fixing the rubber and two vertebrae.

2. The wiper blade structure for an automobile of claim 1, wherein said rubber is provided with two grooves which run the entire length at both sides of the rubber for insertion of said two vertebrae.

3. The wiper blade structure for an automobile of claim 1, wherein said two vertebrae outwardly protrude from both sides of the rubber.

4. The wiper blade structure for an automobile of claim 3, wherein said two vertebrae are made of plate spring.

5. A wiper blade structure, comprising:
a rubber having a blade portion and a body portion integrally molded as a single piece, the body portion defining outwardly open, longitudinally extending channels having a depth;
stiffening vertebrae disposed in said channels, wherein said vertebrae have a width greater than the channel depth such that the vertebrae extend beyond the body portion; and
at least two fasteners conforming to an outer profile of the rubber and stiffening vertebra to hold the vertebrae in said channels.

6. The wiper blade structure according to claim 5, wherein said fasteners include outward extending flange sections surrounding the vertebrae.

7. The wiper blade structure according to claim 5, wherein said rubber further comprises an integrally molded spoiler portion extending from the body portion opposite the blade portion running longitudinally along the body portion and said fasteners are shaped to accommodate said spoiler portion.

8. The wiper blade structure according to claim 5, wherein said structure exhibits a lifting force of less than about 30 N at a vehicle speed of approximately 200 km/hr.

9. The wiper blade structure according to claim 8, wherein the lifting force is less than about 25 N at approximately 200 km/hr.

10. The wiper blade structure according to claim 5, wherein said structure applies a distributed load to a wind shield that is substantially constant over a middle section of the structure.

11. The wiper blade structure according to claim 10, wherein the middle section comprises at least about 60% to 68% of the structure.
